(19) United States
(12) Patent Application Publication
(10) Pub. No.: US 2020/0298101 A1
(43) Pub. Date: Sep. 24, 2020

(54) TOUCH CONTROL HANDLE DEVICE AND ENTERTAINMENT SYSTEM USING SAME

(71) Applicant: SHANGHAI FLYDIGI ELECTRONICS TECHNOLOGY CO., LTD., Shanghai (CN)

(72) Inventor: Wei HUANG, Shanghai (CN)

(73) Assignee: SHANGHAI FLYDIGI ELECTRONICS TECHNOLOGY CO., LTD., Shanghai (CN)

(21) Appl. No.: 16/759,559

(22) PCT Filed: Jul. 25, 2018
(86) PCT No.: PCT/CN2018/097058

§ 371 Date: Apr. 27, 2020

(30) Foreign Application Priority Data
Oct. 27, 2017 (CN) 201711027693.3

(51) Int. Cl. A63F 13/2145; A63F 13/235; A63F 13/24; G06F 3/044; G06F 3/041

(52) U.S. Cl. CPC A63F 13/2145; A63F 13/235; G06F 3/041662; G06F 3/0446; G06F 3/04144; A63F 13/24

(57) ABSTRACT

Disclosed are a touch control handle device and an entertainment system using the device, wherein the touch control handle device is applied to a capacitive touch screen. The touch control handle device comprises: an input module, a processing module, and an output module. The input module receives an operation of a user and converts same into an input signal, the processing module converts the input signal into a touch control command, and the output module is electrically connected to each signal transmitting electrode and signal receiving electrode on the capacitive touch screen, in order to carry out electrical signal output on the signal transmitting electrodes and the signal receiving electrodes according to the touch control command to simulate a touch operation of a location to be touched.

### FIELD

The present disclosure relates to the technical field of touch control, and particularly relates to a touch control handle device and an entertainment system using the device.

### BACKGROUND

Smart mobile terminals such as smart phones or tablet computers have become very popular nowadays. These smart devices usually use touch screens, such as capacitive touch screens or resistive touch screens, to realize “what you see is what you get” operation, thus being intuitive.

With rapid development of mobile online games, numerous competitive mobile games have emerged in the market, like King of Glory; competitive mobile games have very high operation requirements, but common touch screens of the mobile terminals cannot provide good hand feeling. Therefore, many game handles for the mobile terminal have now emerged.

However, signals are mainly transmuted between the game handles and the mobile terminals though wireless connection (e.g., Bluetooth) or wired connection (e.g. Mini USB interfaces) at present. Wireless connection often has a delay problem but wired connection requires cables, and the game handles need to be equipped will corresponding communication modules for communication, thus adding limitation to the design. Moreover, at present, a lot of game software does not support handles using Bluetooth communication in the market, and thus the handles, such as Bluetooth, cannot be directly operated to pay the games.

### SUMMARY

In view of the above-mentioned disadvantages of the prior art, the objective of the present disclosure is to provide a touch control handle device and an entertainment system using the device, so as to solve the problems in the prior art.

In order to realize the above-mentioned objective and other relevant objectives, the present disclosure provides a touch control handle device applied to a capacitive touch screen. The capacitive touch screen comprises a plurality of signal transmitting electrodes and a plurality of signal receiving electrodes arranged as a crisscross array, wherein touch points are formed at locations where the signal transmitting electrodes and the signal receiving electrodes overlap. The touch control handle device comprises: an input module; a processing module communicatively connected to the input module; and an output module communicatively connected to the processing module, wherein the input module is used for acquiring an operation of a user and generating a corresponding input signal; the processing module is used for converting the input signal into a touch control signal corresponding to a location to be touched on the capacitive touch screen, and a touch control command means to execute a touch operation on the location to be touched on the capacitive touch screen; the output module is electrically connected to the signal transmitting electrodes and the signal receiving electrodes and configured to acquire an excitation signal from the signal transmitting electrodes, generate an analog touch signal according to the excitation signal, and output the analog touch signal to the signal receiving electrodes at the touch points at the location to be touched, so as to simulate the touch operation on the location to be touched.

In order to realize the above-mentioned objective and other relevant objectives, the present disclosure provides a touch control handle device applied to a capacitive touch screen. The capacitive touch screen comprises a plurality of horizontal electrodes and a plurality of longitudinal electrodes arranged as a crisscrossed array and respectively forming capacitance with the ground, wherein touch points are formed at locations where the horizontal electrodes and the longitudinal electrodes overlap. The touch control handle device comprises; an input module; a processing module communicatively connected to the input module; and an output module communicatively connected to the processing module, wherein the input module is used for acquiring an operation of a user and generating a corresponding input signal; the processing module is used for converting the input signal into a touch control signal corresponding to a location to be touched on the capacitive touch screen, and a touch control command means to execute a touch operation on the location to be touched on the capacitive touch screen; the output module is electrically connected to the signal transmitting electrodes and the signal receiving electrodes to generate an analog touch signal according to the touch control command, and output the analog touch signal to the horizontal electrodes and the longitudinal electrodes at the touch points at the location to be touched, so as to simulate the touch operation on the location to be touched.

In one embodiment of the present disclosure, the processing module comprises a programmable interlace module used for receiving a selection command to perform selection in a plurality of preset configurations for use, and the plurality of preset configurations are respectively corresponding to different mapping relations between input signals and touch control signals.

In one embodiment of the present disclosure, the programmable interface module is communicatively connected to a first wireless communication module to be competed to an external device in a wireless communication way, so as to configure the programmable interface module.

In one embodiment of the present disclosure, the first wireless communication module contuses the following communication types: 2G/3G/4G mobile communication, WiFi, Bluetooth or infrared communication.

In one embodiment of the present disclosure, the processing module is communicatively connected to a second wireless communication module, the output module is communicatively connected to a second wireless communication module, and the second wireless communication module is connected to the third wireless communication module in a wireless communication way.

In one embodiment of the present disclosure, the second wireless communication module and the third wireless communication module comprise the following communication types: 2G/3G/4G mobile communication, WiFi, Bluetooth or infrared communication.

In one embodiment of the present disclosure, the processing module is communicatively connected to a fourth wireless communication module, the input module is communicatively connected to a fifth wireless communication module, and the fourth wireless communication module is connected to the fifth wireless communication module in a wireless communication way.

In one embodiment of the present disclosure, the fourth wireless communication module and the fifth wireless communication module comprise the following communication types: 2G/3G/4G mobile communication, WiFi Bluetooth or infrared communication.

In order to realize the above-mentioned objective and other relevant objectives, tire present disclosure provides an entertainment system, which includes a mobile terminal comprising a self-capacitive touch screen or a mutual-capacitive touch screen, and the touch control handle device used for realizing touch control on the mobile terminal according to any one of the embodiments.

In one embodiment of the present disclosure, an operation handle of the touch control handle device is fixedly arranged atone side of a top or a bottom of the mobile terminal.

As mentioned above, according to the touch control handle device and the entertainment system applying the same, the touch control handle device is applied to the capacitive touch screen and comprises the input module, the processing nodule and the output module, wherein the input module acquires the operation of the user and converts same into the input signal, the processing module converts the input signal into the touch control command; the output module is electrically connected to the signal transmitting electrodes and the signal receiving electrodes on the capacitive touch screen to perform electric signal output on the signal transmitting electrodes and the signal receiving electrodes according to the touch control command so as to simulate the touch operation on the location to be touched. The touch control handle device of the preset disclosure adopts a touch simulation mode different from the existing devices, responds sensitively and rapidly and promotes user experience.

### BRIEF DESCRIPTION OF THE DRAWINGS

FIG. 1 shows an application schematic diagram of a touch control handle device in an embodiment of the present disclosure.

FIG. 2 shows a schematic diagram of a circuit module of a touch control handle device in an embodiment of the present disclosure.

FIG. 3 shows a schematic diagram of a circuit module of a touch control handle device in another embodiment of the present disclosure.

FIG. 4 shows a schematic diagram of a circuit module of a touch control handle device in yet another embodiment of the present disclosure.

FIG. 5 shows a schematic diagram of a circuit module of a touch control handle device in still yet another embodiment of the present disclosure.

FIG. 6 shows a structural schematic diagram of an output module of a touch control handle device in an embodiment of the present disclosure.

FIG. 7 shows a structural schematic diagram of an output module of a touch control handle device in another embodiment of the present disclosure.

FIGS. 8a-8e show structural schematic diagrams of components h an output module which are arranged in a capacitive touch screen in a plurality of embodiments of the present disclosure.

### DETAILED DESCRIPTION OF THE EMBODIMENTS

The implementations of the present disclosure are described below by way of specific embodiments, and those skied in the art can easily understand other advantages and effects of the present disclosure from the content disclosed in the specification.

Please refer to the figures below. It should be noted that the structures, scales, sizes, etc., which are drawn in the accompanying drawings of the specification are only intended for supplementing the content disclosed in the specification and for those skilled in the art to understand and read, rather than defining imitations to the implementations of the present disclosure, thus having no technologically essential meaning. Any structural modifications, scale relation changes or size adjustment shall fall within the scope winch can be covered by the technical content disclosed by the present disclosure in the case of not affecting the effects and objectives of the present disclosure. Meanwhile, terms referenced in the specification, such as “upper”, “lower”, “left”, “right”, “middle” and “first”, are only attended for clear statement rather than limiting the implementable scope of the present disclosure. Changes or adjustment of the relative relations should also be regarded as being within the implementable scope of the present disclosure in the case of no substantial change of the technical content.

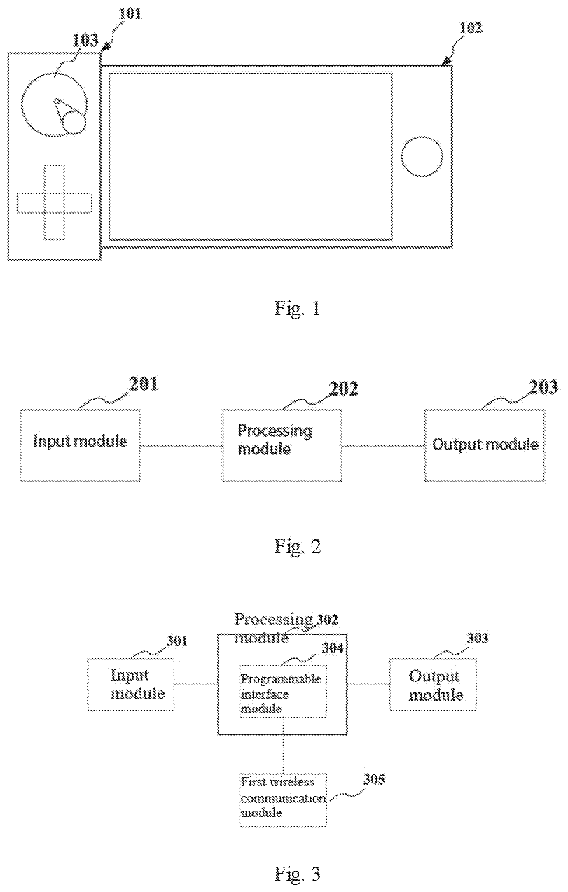

With reference to FIG. 1, an embodiment of a touch control handle device 101 is shown. The touch control handle device 101 receives an operation of a user to realize corresponding touch operation on a touch screen (e.g., a capacitive touch screen) of a mobile terminal 102, thus achieving purposes that the user plays games or uses software on the mobile terminal, and the like.

The touch control handle device 101 can be preferably arranged atone side of a top or bottom of the mobile terminal 102 (e.g., a mobile phone), to facilitate operations of games on the mobile terminal 102 in a landscape mode.

The touch control handle device 101 comprises an input module 103 comprising a joystick and/or keys. In an embodiment of FIG. 1, the joystick and the keys are arranged on one side of the mobile terminal 102, and can be operated by the left hand of the user, and operating the joystick and the keys by the user is equivalent to operating virtual joystick and keys on the touch screen; the user can operate the touch screen on the right side of the mobile terminal 102 with the right hand.

Of course, the embodiment of FIG. 1 only shows a solution of operation with a single handle, however, it is foreseeable that a solution of two handles arranged on two skies can also be contained in the present application, and is not limited by the embodiment of FIG. 1.

FIG. 2 shows a schematic diagram of a circuit module of a touch control handle device in an embodiment of the present disclosure.

The touch control handle device comprises an input module 201, a processing module 202 and an output module 203.

The input module 201, as mentioned above, comprises a joystick and/or keys and is used for generating a corresponding input signal by receiving a user input.

The processing module 202 is communicatively connected to the input module 201, and is used for converting the input signal into a touch control signal corresponding to a location to be touched on the capacitive touch screen. In one embodiment of the present disclosure, the touch control signal contains the coordinate information of one or more touch points of the location to be touched on a plane of the capacitive touch screen.

The output module 203 is communicatively connected to the processing module 202 and electrically connected to the touch screen, and is used for simulating the touch operation on the location to be touched according to the touch control signal.

As shown in FIG. 3, a touch control handle device in an embodiment comprises an input module 301, a processing module 302 and an output module 303, wherein the processing module 302 comprises a programmable interlace module 304 which can perform implementation on a plurality of configuration programs preset in the processing module 302, and can communicate with an external device to receive a selection command from the external device so as to select a configuration program for use; specifically, the plurality of configuration programs are respectively corresponding to different mapping relations between input signals and touch control signals, namely, corresponding to different operation modes, that is in each operation mode, the joystick and/or keys in the input module function differently when being used.

The operation modes can be corresponding to different games, for example, a game. A matches with a configuration program hand in the corresponding operation mode, the key A is corresponding to a function “attack” in the game A; a game B matches with a configuration program 2, and in the corresponding operation mode, the key A is corresponding to a function “menu bar” in the game B.

Alternatively, in different operation modes, the functions realized by operating the joystick in the up, down, left and right directions may be implemented by touching different locations on the touch screen, or the operable ranges are different.

In one embodiment of the present disclosure, as shown in FIG. 3, the programmable interface module 304 is communicatively connected to a first wireless communication module 305 which can be a 2G/3G/4G mobile communication, WiFi, Bluetooth or infrared communication module to be connected to the external device in a wireless communication way to receive a selection command.

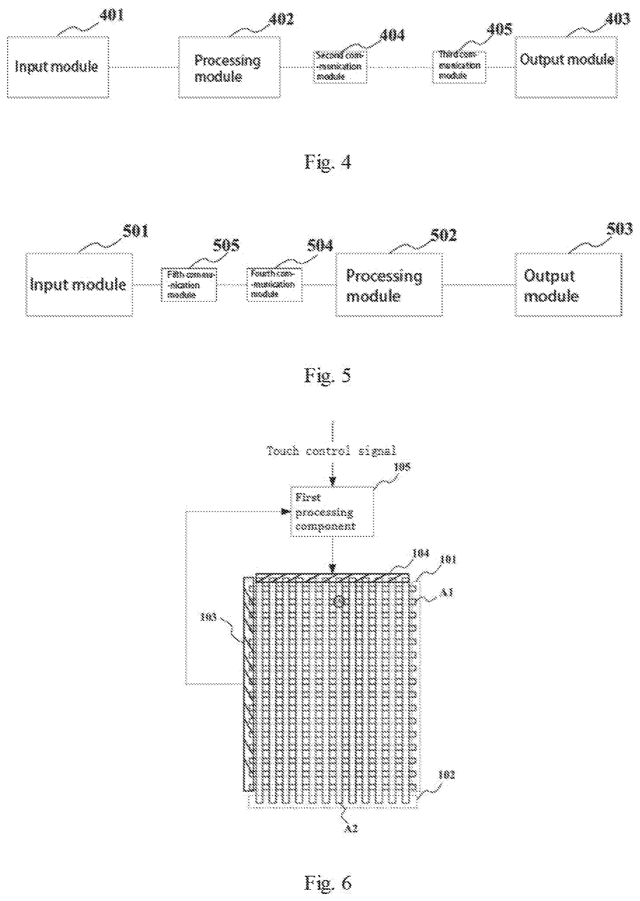

As shown in FIG. 4, a touch control handle device in an embodiment comprises an input module 401, a processing module 402 and an output module 403, wherein the processing module 402 and the output module 403 can be mutually connected by wireless communication, the processing module 402 is communicatively connected to a second wireless communication module 404, the output module 403 is communicatively connected to a third wireless communication module 405, and the second wireless communication module 404 is connected to the third wireless communication module 405 by wireless communication.

In one embodiment, the second wireless communication module 404 and the third wireless communication module 405 comprise the following communication types: 2G/3G/4G mobile communication, WiFi, Bluetooth or infrared communication.

As shown in FIG. 5, a touch control handle device in an embodiment comprises an input module 501, a processing module 502 and an output nodule 503, wherein the processing module 502 and the input module 501 can be mutually connected in a wireless communication way; the processing module 502 is communicatively connected to a fourth wireless communication module 504, the input module 501 is communicatively connected to a fifth wireless communication module 505, and the fourth wireless communication module 504 is connected to the fifth wireless communication module 505 by wireless communication.

In one embodiment, the fourth wireless communication module 504 and the fifth wireless communication module 505 comprise the following communication types: 2G/3G/4G mobile communication, WiFi, Bluetooth or infrared communication.

Though a structure in the embodiment of FIG. 4 or FIG. 5, the connection between the processing module and the input module and/or output module can be more flexible.

The touch control handle device of the present disclosure is used for touch control of a capacitive touch screen which includes a self-capacitive touch screen and a mutual-capacitive touch screen. Depending on different principles, the self-capacitive touch screen only allows single-touch while rite mutual-capacitive touch screen a Bows multi-touch. Therefore, the mutual-capacitive touch screen is most commonly used.

Will reference to FIG. 6, a structural schematic diagram of a specific implementation of an output module in a touch control handle device in an embodiment is shown. In the embodiment, the touch control handle device is applied to a mutual-capacitive touch screen which comprises a plurality of signal transmitting electrodes 601 and a plurality of signal receiving electrodes 602 arranged as a crisscross array, wherein touch points are formed at locations where the signal transmitting electrodes 601 and the signal receiving electrodes 602 overlap.

Capacitance is formed at the locations where the signal transmitting electrodes 601 intersect with and the signal receiving electrodes 602, that is, the two sets of electrodes respectively form two poles of the capacitance. When the finger touches the capacitive touch screen, coupling between the signal transmitting electrodes 601 and the signal receiving electrodes 602 at one or more touch points is affected, thus changing the capacitance between the two sets of electrodes.

The touch location is apiece of two-dimensional information containing a horizontal coordinate (X) and a longitudinal coordinate (Y), wherein the X coordinate determines tire selection and the amplification times of various excitation signals, while the Y coordinate determines the location selection and amplification times of the output signal; when mutual capacitance is detected, the horizontal signal transmitting electrodes 601 send excitation signals in sequence, and the longitudinal signal receiving electrodes 602 receive the signals at the same time, so that capacitance values at the intersection points of the horizontal and longitudinal electrodes can be obtained, namely the capacitance of a two-dimensional plane of the entire touch screen. The coordinate of each touch point can be calculated according to the two-dimensional variation data of the capacitance of the touch screen. Therefore, even if a plurality of touch points are on the touch screen, the real coordinate of each touch point can be calculated.

The output module comprises a signal collection component 603, a first signal output component 604 and a first processing component 605.

The signal collection component 603 is used to be electrically coupled with the signal transmitting electrodes 601 of the capacitive touch screen to acquire the excitation signals, and comprises electrodes for realizing the electric coupling.

The first signal output component 604 is used to be electrically coupled with the signal receiving electrodes 602 of the capacitive touch screen to output analog touch signals, and comprises electrodes for realizing the electric coupling.

The list processing component 605 is communicatively connected to the signal collection component 603 and the first signal output component 604, wherein the first processing component 605 is used for receiving a touch control command, the touch control command means to execute the touch operation on the location to be touched on the capacitive touch screen; the first processing component 605 is used for receiving the excitation signals of the signal receiving electrodes at the touch points at the location to be touched, generating the analog touch signals according to the excitation signals, and outputting the analog touch signals to the signal receiving electrodes 602 at the touch points at the location to be touched via the first signal output component 604, so as to simulate the touch operation on the location to be touched.

The analog touch signals result from amplifying the excitation signals to cause capacitance value variation at the corresponding touch points, and simulate the effect of superposing capacitance variation at the time of finger touch, thus generating trigger operation.

For example, if the touch operation on a point A in an image needs to be triggered, the touch operation on the point A is implemented by acquiring an excitation signal from a signal transmitting electrode A1 where the point A is located, processing the excitation signal into an analog touch signal and sending the analog touch signal to the signal receiving electrode A2 where the point A is located.

Optionally, the signal collection component 603 or the first signal output component 604 can comprise a body made of a transparent material and electric lines in the body; the transparent material is (for example) glass, acrylic, etc., winch does not affect watching on the capacitive touch screen even when covering the surface of the capacitive touch screen; of course, the body may not be made of transparent material and is not limited thereto.

Optionally, the first processing component 605 can be integrated in the processing module to reduce the cost and the circuit complexity.

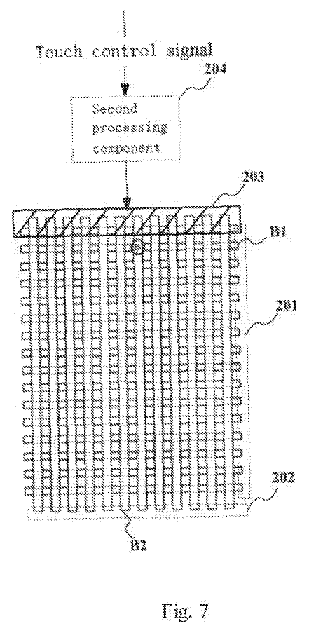

Will reference to FIG. 7, a structural schematic diagram of a specific implementation of an output module in a touch control handle device in another embodiment of the present disclosure is shown.

Different from the previous embodiment, the touch control handle device in the embodiment is applied to a self-capacitive touch screen. Different contents at the embodiments are introduced hereinafter, and technical details which can be commonly used between the embodiments are not described again.

The capacitive touch screen comprises a plurality of horizontal electrodes 701 and a plurality of longitudinal electrodes 702 arranged as a crisscrossed array and respectively forming capacitance with the ground, wherein touch points are formed at locations where the horizontal electrodes 701 and the longitudinal electrodes 702 overlap, and when the finger touches the capacitive touch screen, the capacitance on the finger is overlapped to the formed capacitance, increasing the capacitance.

In the embodiment, the touch control handle device comprises a second signal output component 703 and a second processing component 704.

The second signal output component 703 is used to be electrically coupled with the horizontal electrodes 701 and the longitudinal electrodes 702 of the capacitive touch screen; and

the second processing component 704 is communicatively connected to the second signal output component 703, wherein the second processing component 704 is used for receiving a touch control command, the touch control command means to execute the touch operation on a location to be touched on the capacitive touch screen; the second processing component 704 is used for generating a analog touch signal according to the touch control command, and outputting the analog touch signal to the horizontal electrodes 701 and the longitudinal electrodes 702 at the touch points at the location to be touched via the second signal output component 703, so as to simulate the touch operation on the location to be touched.

Depending on the difference of the working principles of the self-capacitive touch screen and the mutual-capacitive touch screen, in the embodiment, when the touch operation is required to be performed on a certain location to be touched, only the ground capacitance of the horizontal electrodes 701 and the longitudinal electrodes 702 of the touch points at the location to be touched needs to be changed.

For example, when the touch operation on a point B in a figure needs to be triggered, the touch operation on the point B can be implemented by changing the capacitance of a horizontal electrode B1 and a longitudinal electrode B2 where the point B is located.

It should be noted that the processing module, the first processing component and the second processing component in the above-mentioned embodiment can be realized through a processing system which comprises a processor (e.g., CPU, MCU, SOC, etc.,) and a memory (RAM, ROM, etc.,) and an interface (IO interlace, USB interface, etc.,) winch are connected to the processor, wherein programs are stored in the memory, and the processor runs the programs to realize the various above-mentioned functions.

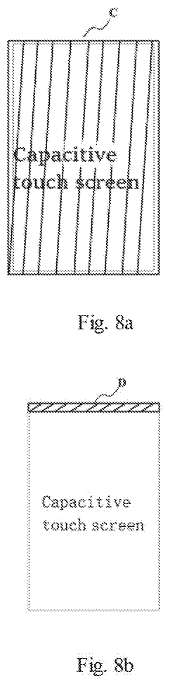

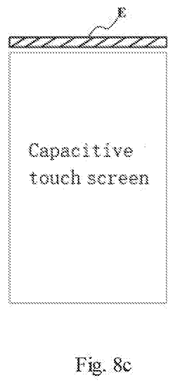

In the above-mentioned embodiment, the signal collection component, the first signal output component and the second signal output component can at least partially cover the surface of the capacitive touch screen, it view of structure setting. For example, as shown in FIG. 8a, components, like an article C, can cover the entire surface of the capacitive touch screen; or as shown in FIG. 8b, components, like an article D, can cover the partial surface of the capacitive touch screen, e.g., at least a margin on one side of the capacitive touch screen; in other embodiments, the components can also cover margins on two connected sides to form an “L” shape; or, since direct contact is not necessary for electric coupling, the components can be kept a distance away from the electrodes, for example, as shown in FIG. 8c, the components, like an article E, can be arranged close to the capacitive touch screen.

In summary, the present disclosure provides a touch control handle device and an entertainment system applying the same. The touch control handle device is applied to a capacitive touch screen. The touch control handle device comprises an input module, a processing module and an output module; the input module receives an operation of a user and converts same into an input signal, the processing module converts the input signal into a touch control command, and the output module is electrically connected to signal transmitting electrodes and signal receiving electrodes on the capacitive touch screen to output an electric signal at the signal transmitting electrodes and the signal receiving electrodes according to the touch control command, to simulate a touch operation at a location to be touched. The touch control handle device of the present disclosure has a touch simulation mode completely different from the existing devices, responds sensitively and quickly, and promotes the user experience.

According to the technical solution of the present disclosure, the touch signal is simulated directly, so that the operation of any touch screen games can be supported perfectly, and SDK for handle operation does not need to be accessed by game developers.

The present disclosure effectively overcomes various defects in the prior art, thus having a high industrial use value.

The above-mentioned embodiments merely exemplarily illustrate the principle and effects of the present disclosure, and are not intended to limit the present disclosure. Those skilled in the art can modify or change the above-mentioned embodiments without departing from the spirit and scope of the present disclosure. Therefore, all equivalent modifications or changes made by the person with ordinary knowledge in the technical field without departing from the sprit and technical idea disclosed by the present disclosure should still be covered by the claims of the present disclosure.

1. A touch control handle device, applied to a capacitive touch screen which comprises a plurality of signal transmitting electrodes and a plurality of signal receiving electrodes arranged as a crisscross array, wherein touch points are formed at locations where the signal transmitting electrodes and the signal receiving electrodes overlap; and the touch control handle device comprises:
an input module;
a processing module communicatively collected to the input module;
an output module communicatively connected to the processing module, where
the input module is used for acquiring an operation of a user and generating a corresponding input signals; the processing module is used for converting the input signal into a touch control signal corresponding to a location to be touched on the capacitive touch screen, and a touch control command means to execute a touch operation on the location to be touched on the capacitive touch screen; the output module is electrically connected to the signal transmitting electrodes and the signal receiving electrodes to acquire excitation signals from the signal transmitting electrodes, generate analog touch signals according to the excitation signals, and output the analog touch signals to the signal receiving electrodes at the touch points at the location to be touched, so as to simulate the touch operation on the location to be touched.

2. A touch control handle device, applied to a capacitive touch screen which comprises a plurality of horizontal electrodes and a plurality of longitudinal electrodes arranged as a crisscross array and respectively forming capacitance with the ground, wherein touch points are formed at locations where the horizontal electrodes and the longitudinal electrodes overlap; and the touch control hurdle device comprises;
an input module;
a processing module communicatively connected to the input module; and
an output module communicatively connected to tire processing module, where
the input module is used for acquiring an operation of a user and generating a corresponding input signal; the processing module is used for converting the input signal into a touch control signal corresponding to a location to be touched on the capacitive touch screen, and a touch control command means to execute a touch operation on lire location to be touched on tire capacitive touch screen; the output module is electrically connected to signal transmitting electrodes and signal receiving electrodes to generate analog touch signals according to tire touch control command, and output tire analog touch signals to the horizontal electrodes and the longitudinal electrodes at the touch points at the location to be touched, so as to simulate the touch operation on the location to be touched.

3. The touch control handle device according to claim 1, wherein the processing module comprises a programmable interface module used for receiving a selection command to perform selection a plurality of preset configurations for use, and the plurality of preset configurations are respectively corresponding to different mapping relations between the input signals and the touch control signals.

4. The touch control handle device according to claim 3, wherein the programmable interface module is communicatively connected to a first wireless communication module to be connected to an external device in a wireless communication way, so as to configure the programmable interlace module.

5. The touch control handle device according to claim 1, wherein the first wireless communication module comprises following communication types: 2G/3G/4G mobile communication, WiFi Bluetooth or infrared communication.

6. The touch control handle device according to claim 1, wherein the processing module is communicatively connected to a second wireless communication module, the output module is communicatively connected to a third wireless communication module, and the second wireless communication module is connected to the third wireless communication module by wireless communication.

7. The touch control handle device according to claim 6, wherein the second wireless communication module and the third wireless communication module comprise following communication types: 2G/3G/4G mobile communication, WiFi, Bluetooth or infrared communication.

8. The touch control handle device according to claim 1, wherein the processing module is communicatively connected to a fourth wireless communication module, the input module is communicatively connected to a fifth wireless communication module, and the fourth wireless communication module is connected to the fifth wireless communication module by wireless communication.

9. The touch control handle device according to claim 8, wherein the fourth wireless communication module and the fifth wireless communication module comprise following communication types: 2G/3G/4G mobile communication, WiFi, Bluetooth or infrared communication.

10. An entertainment system, comprising:
a mobile terminal, comprising a self-capacitive touch screen or a mutual-capacitive touch screen; and
the touch control handle device according to claim 1, used for realizing touch control on the mobile terminal.

11. The entertainment system according to claim 10, wherein a handle of the touch control handle device is fixedly arranged on one side at a top or a bottom of tire mobile terminal.
